(19) United States
(12) Patent Application Publication
(10) Pub. No.: US 2009/0307508 A1
(43) Pub. Date: Dec. 10, 2009

(54) Optimizing the Efficiency of an Organization's Technology Infrastructure

(75) Inventors: Donald Steve Curtis, Charlotte, NC (US); Dean George Algir Johnson, Milford, PA (US); Jacqueline Nantz Ely, Charlotte, NC (US); Wing-Chun Virginia Cho, Whitestone, NY (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 11/929,229

(22) Filed: Oct. 30, 2007

(51) Int. Cl. G06F 1/32; G06F 7/00; G06F 9/46

(52) U.S. Cl. 713/320; 707/100; 718/100; 707/E17.044

(57) ABSTRACT

This disclosure is directed to a method and system for optimizing a technology infrastructure of an organization. It includes a step or component for collecting source data from various aspects of technology infrastructure. It also includes a step or component for processing the source data to generate information regarding the technology infrastructure. It further includes creating goals regarding the optimization process of the technology infrastructure based on the information from the processed source data and generating a report wherein the goals are presented. The optimization of the technology infrastructure may include migrating non-core operating systems of hardware to consistent operating systems, leveraging the hardware and maximizing the CPU and storage utilization of the remaining core hardware in order to reduce the number of locations in the organization to thereby decrease the operating and fixed costs of organization the power consumption of the organization its associated environmental impact.

### BACKGROUND

Many organizations, for example corporations and businesses, have a substantial investment in the technology infrastructure they use to support their business. However, often this technology infrastructure may be underutilized and inefficient. An organization operating with such an underutilized and inefficient technology infrastructure experiences unnecessary expenditure of resources which, in turn, leads to the organization incurring unnecessary financial costs.

One particular problem that an organization faces in controlling the costs associated with its technology infrastructure is hardware transparency. Hardware transparency refers to the organization's ability to know and understand their existing hardware's capacity and capability. Often information about the organization's hardware may be unknown, or at least unclear, to the organization's management. For example, basic information about the organization hardware, e.g. the number of computer servers may be unknown or unclear. Further, information about the organization's servers, such as: where those servers are located, what those servers are running, the efficiency of those servers, the costs associated with those servers, etc. may all be unclear to the organization's management. Due to this lack of infrastructure transparency, the organization would find it difficult to determine many aspects regarding the efficiency and capability of its technology infrastructure. In fact, this lack of operating system and hardware transparency leads to increased costs for the organization.

For example, the operating costs of an organization may be increased due to the lack of hardware transparency. One operating cost relates to the power consumption of the non-core (e.g., obsolete, non-preferred) hardware. Some non-core hardware may no longer be utilized in an infrastructure environment, but still be “plugged in” and drawing power. Therefore, that power and the cost associated with obtaining it, are a waste of the organization's finances. Another aspect relates to the fact that by not appreciating the capacity and capability of the existing hardware, the organization might actually expend finances to purchase additional hardware when it is not needed. Not only are the organization's finances wasted on the purchase of additional hardware that is not needed, but the additional hardware will now draw power which again increases the operating costs unnecessarily.

Further, the fixed costs of the operating may be increased due to the lack of hardware transparency. First, non-core hardware is still housed by the organization in one of its locations (e.g. data centers). Also, the above-described additional unnecessary hardware, if purchased, must also be housed by the organization. Both the non-core and the unnecessary additional hardware reduce available space in the data center. Once this space capacity is reached, the organization would actually have to increase the number of data centers in order to maintain the organization's technological infrastructure. Secondly, and perhaps, more importantly each data center has a predetermined power limit available to it based on its connections to the actual power grid (usually in the range of several Megawatts). As stated above, both the non-core and unnecessary additional hardware would draw power that would contribute to towards the overall power limit. Once that power limit is nearly reached, the organization would again actually need to increase the number of data centers in order to maintain the organization's technology infrastructure. The expansion of the data centers due to the lack of hardware transparency increases the fixed costs of the organization (e.g. leasing or purchasing the space or property). Further, there are always additional operating costs associated with the expansion of the data centers and, therefore, the operating costs of the organization would further increase.

In addition to the increased costs for an organization, the lack of hardware transparency may also lead to a waste of power and also an increased environmental impact. The use of power has a corresponding environmental consequence. For example, there may be a greenhouse gas emission in the form of carbon dioxide (CO₂) attributable to the use of power. Unnecessarily increasing the use of power correspondingly unnecessarily increases the CO₂ produced and, therefore, unnecessarily increases the organization's environmental impact.

There exists the need for a method and a system which will allow an organization to concisely understand the existing status of the organization's technology infrastructure and further optimize the technology infrastructure based that information.

### SUMMARY

The following disclosure is directed to a method and system for concisely determining and reporting the existing status of an organization's technology infrastructure and further, optimizing the technology infrastructure based on information reported.

Aspects of the present disclosure include a method and system that are tools which target particular aspects of the technology infrastructure for improvement. These tools allow an organization to clearly and concisely view these particular targeted aspects of their technology infrastructure. In essence, these tools provide hardware and operating system transparency. Based on this information from these tools, the organization can: determine areas of the technology infrastructure that can be optimized; provide recommendations and goals for achieving such optimization; and provide updates on whether those goals are being achieved within predetermined time frames.

One aspect of this disclosure relates to a method and system for optimizing a technology infrastructure of an organization. It includes a step or component for collecting source data from various aspects of technology infrastructure. It also includes a step or component for processing the source data to generate information regarding the technology infrastructure. It further includes creating goals regarding the optimization process of the technology infrastructure based on the information from the processed source data and generating a report wherein the goals are presented.

A further aspect of this disclosure relates to the optimization of the technology infrastructure and may include remediation of non-core operating systems and hardware; leveraging existing hardware that has already been purchased, and maximizing the CPU and storage utilization of the remaining core hardware in order to reduce the number of locations in the organization to thereby decrease the operating and fixed costs of organization, the power consumption of the organization and its associated environmental impact.

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

FIG. 1 is a flowchart of a preferred method or system according to one aspect of this disclosure.

FIG. 2 is an example of table generated from the second step/component generated according to the process/system according to one aspect of this disclosure.

FIG. 3 is another example of table generated from the second step/component according to the process/system according to one aspect of this disclosure.

FIG. 4 is an illustrative embodiment of a report according to one aspect of this disclosure.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made.

The following disclosure is directed to a method and system for concisely determining and reporting the existing status of an organization's technology infrastructure and further, optimizing the technology infrastructure based on information reported.

This method and system are tools which target particular aspects of the technology infrastructure for improvement. These tools allow an organization to clearly and concisely view these particular targeted aspects of their technology infrastructure. In essence, these tools provide hardware and operating system transparency. Based on this information from these tools, the organization can: determine areas of the technology infrastructure that can be optimized; provide recommendations and goals for achieving such optimization; and provide updates on whether those goals are being achieved within predetermined time frames.

In one feature of the following disclosure, these targeted aspects of the technology infrastructure include: computer servers, operating systems, storage systems, data centers and the technology infrastructure's use of power and related environmental impact. According to this feature of the present disclosure, the optimization of the organization's technology infrastructure may include: standardizing the operating systems of the hardware, leveraging existing hardware (vs. purchasing new and not using what is already owned), maximizing the CPU utilization of the hardware, maximizing the storage utilization of the hardware, reducing the number of data centers and decreasing the power consumption along with the power consumption's related environmental impact. Each of these aspects is discussed in further detail below.

Standardizing the Operating System

An organization may have many different software applications for performing different functions throughout is technology infrastructure. These different software applications may be supported by different operating systems. The disparity and variance between the different operating systems can complicate the overall technology infrastructure. As the number of different operating systems (and distinct versions of those operation systems) in an environment increases, the complexity of the infrastructure can become unwieldy. This is in part due to the fact that each operating system requires a specific skill set in support personnel, has unique upgrade path and maintenance requirements, and has unique criteria for interoperability with other platforms. Further, some operating systems may be non-core (i.e. obsolete or non-preferred) which limits interoperability and denies the application developers use of features present in consistent (modern or preferred) operating systems. It would, therefore, be beneficial to reduce the complexity of the overall technology infrastructure by standardizing the different operating systems to consistent, up-to-date versions of the operating system. For example, in regard to computer servers, any computer server that is running a non-core operating system could be updated to a consistent, up-to-date version of an operating system. Once all the non-core operating systems of the servers are migrated to consistent operating systems, the applications operating on those servers can be consolidated and optimized to operate on existing core hardware. This allows the amount of hardware required to operate the servers to be reduced. Since less hardware is required, non-core hardware can be removed from the technology infrastructure as described below.

Leveraging the Hardware

The server hardware may be a substantial component of the technology infrastructure. Over time such hardware may become obsolete (e.g., some of the server hardware that is currently operating may no longer be supported by the vender). Further, some of the hardware, while not obsolete, may just be older or have less capacity or capability. As described above, the consolidation of operating systems allows like functions to be consolidated onto existing core servers. By leveraging the existing core servers, the overall amount of hardware is reduced. Preferably, it is the non-core (e.g. obsolete or non-preferred) hardware that should be removed from the technology infrastructure (although it is noted that other superfluous hardware, even if up to date, may also be removed if its removal will add to the optimization of the technology infrastructure). The leveraging of the core hardware and the removal of the non-core hardware reduces the total operating costs of the organization and also reduces the organization's overall power consumption. For example, non-core hardware that is removed can no longer draw power and therefore will not contribute to the organization's overall power consumption. Therefore, that elimination of unnecessary power consumption will decrease the operating costs of the organization.

In addition, removing the non-core hardware from the technology infrastructure, contributes to hardware transparency. In other words, removing the non-core hardware from the technology infrastructure will eliminate unnecessary complexity that will otherwise hinder an organization's management attempting to assess the ability of the technology infrastructure as it relates to the amount hardware resources available, whether hardware is operating efficiently, etc. The operating efficiency of the hardware in the technology infrastructure is described below.

Maximizing the Hardware's CPU Capacity Utilization

### Maximizing the Hardware's CPU Utilization

As described previously, the hardware in a technology infrastructure may not be used efficiently. For example, an organization's computer server hardware may be underutilized and not running at a preferred capacity. A server's CPU utilization relates the ratio of the time the server spends working versus the time spent sitting idle. Implementing the above two features of (1) moving the operating systems to consistent operating systems and, in turn, (2) leveraging the hardware (consolidating preferred hardware and removing non-core hardware), this leads to an opportunity to increase the server hardware's CPU utilization, because it allows like functions to be consolidated on the remaining server hardware. This consolidation of functions on the existing hardware platform creates additional available capacity on the remaining server hardware. Therefore, the additional available capacity of the server hardware may be re-designated and utilized for the implementation of other tasks, such as supporting new projects. By implementing new projects on existing servers, the infrastructure's CPU utilization rate as a whole is significantly increased. Therefore, the organization will be able to significantly curtail financial waste. For example, consider that without such consolidation to create additional available space onto the existing server hardware and re-designation of that available space to new projects, new hardware would have to be purchased to run the additional new projects. Instead, the new projects now may be operated on the more efficient existing servers.

Maximizing the Hardware's Storage Utilization

Similarly to the above described server's CPU capacity utilization, the storage utilization associated with the servers also may be underutilized. A server's storage utilization relates to how much of the server storage capacity is already expended and conversely how much of the server storage capacity remains available. For example, such storage capacity may be partially or even significantly unused.

Just as with the above described server's CPU capacity utilization, by implementing the above two features of (1) moving the operating systems to consistent operating systems and, in turn, (2) leveraging the hardware leads to an opportunity to increase the server hardware's storage utilization, because it allows like functions to be consolidated on the remaining server hardware. This consolidation of function on the existing hardware platforms will create additional available space on the server hardware. Therefore, the additional available storage space of the server hardware may be re-designated and utilized for storing other data. Hence, by implementing new projects on existing server hardware, the server hardwares' storage utilization is significantly increased. Overall, throughout the technology infrastructure, increased storage capacity increases the efficiency of the technology infrastructure. Therefore, the organization is able to significantly curtail financial waste.

### Reducing the Number of Data Centers

Implementation of the above described features allows for the technology infrastructure to be streamlined and more efficient. Further, another result of the implementation of the above features is that they provide the opportunity to reduce the number of data centers in the organization. As described above, there are fixed costs associated with each data center and reducing the number of data centers reduces the overall fixed costs of the organization.

According to one aspect of this disclosure, these above-described processes allow for the core server hardware to be consolidated and the non-core server hardware to be removed from the technology infrastructure. The consolidation and removal of the server hardware results in less hardware throughout the technology infrastructure. The reduced amount of server hardware allows the entire technology infrastructure to be consolidated. In other words, the number of data centers in the organization may be reduced to a remaining core number of data centers. This is advantageous to an organization because the reduction in locations of an organization reduces the amount of fixed costs of the organization. For example, if an organization with 50 data centers can reduce its technology infrastructure down to 10 data centers using the above method, the savings in the amount of fixed costs alone is extremely substantial. Further, the consolidated infrastructure can be migrated to core data centers (data centers that are desirable from a cost, expandability, power capacity, or green house gas emissions perspective) with less risk and complication than the non-optimized infrastructure. It is worth noting that some organizations may actually expand the number of data centers to maintain its technology infrastructure (e.g. corporations may expand the number of data centers based on the above mentioned power constraints). Therefore, this system, which reduces the amount of data centers, would be desirable because unless data centers are reduced, the fixed costs remain.

Reducing the Power

Further, the reduction of data centers in an organization also reduces the overall power consumption of the organization. Therefore, in addition to the inherent effect of conserving energy, the operating costs, such as the finances expended for obtaining power is reduced. This provides a financial savings for the organization.

Additionally, the reduction of data centers in an organization also reduces the environmental effects generated by the organization. As described above, power used by the organization has an environmental impact. For example, there is a greenhouse gas emission in the form of carbon dioxide (CO₂) attributable to the use of power. Reducing the amount of data centers reduces the power and, therefore, reducing the data centers correspondingly reduces the amount of carbon dioxide (CO₂) produced by the organization. Hence, not only does the above feature provide financial improvements for the organization, but also provides a beneficial effect on the environment.

The Optimization Process/System

While the above described targeted aspects (e.g. standardizing the operating systems, levering of the hardware, increasing of the CPU and storage utilization) may be modified to optimize an organization's technology infrastructure, the current status of such targeted aspects in the technology infrastructure must first be determined. There is a tremendous amount of data regarding these targeted aspects. This exorbitant amount of information is one factor that causes a lack of hardware transparency and in general prevents the organization from realizing the capabilities, waste, etc. of its technology infrastructure.

Therefore, one feature of this disclosure relates to a method and system that provides hardware transparency and allows an organization to optimize its technology infrastructure. This method and system allows an organization to clearly and concisely understand these particular aspects of their technology infrastructure. Based on this information provided by this system and method, the organization may: determine aspects of the technology infrastructure that can be optimized, provide recommendations and goals for achieving such optimization, and further, can provide updates on whether those goals are being achieved within predetermined time frames.

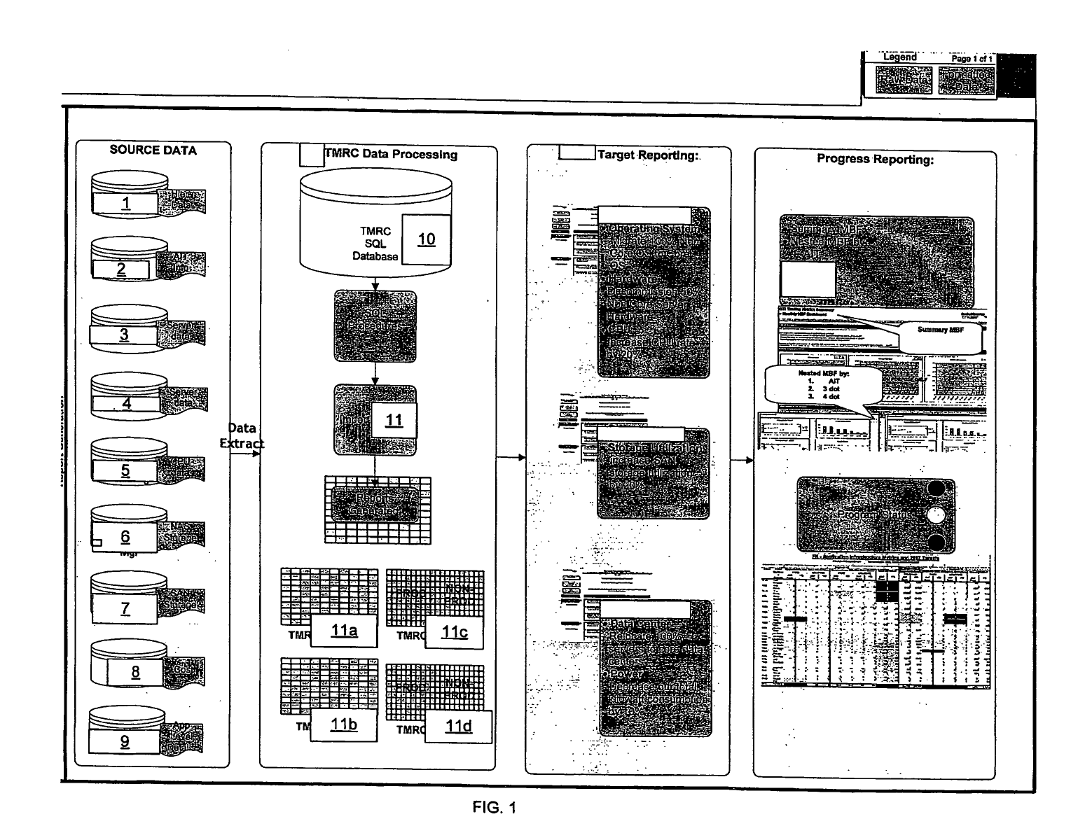

FIG. 1 discloses a flow chart which contains an illustrative embodiment of the above described method and system. As shown in FIG. 1, the process or system includes several steps or components. For example, the first step or component is gathering the source data regarding the organization's technology infrastructure. The second step or component is processing the source data to create information about the technology infrastructure and using that information to determine and current the existing status of the technology infrastructure. The third step or component is using the information from the second step or component to create goals for implementing changes to the existing technology infrastructure in order to optimize it. The fourth step or component is to report the progress towards reaching the goals of the third step or component in a report that is concise for the reader to understand.

Gathering Source Data

As seen in the illustrated embodiment shown in FIG. 1, the first step or component of the method or system is to gather the source data. In this initial step, data regarding the technology infrastructure is extracted from different data sources. This is raw data that will be imported into a system for analysis. The data sources from which the data is extracted will vary depending on the particular organization. In the depicted embodiment, the data relates to organization's technology infrastructure and contains data regarding facets of the computer servers and may include, inter alia, information on web, middleware, messaging and database servers. Sources from which data is extracted to create the raw data may include a centralized database (1) about the software applications developed, maintained and used by the organization. Other sources for providing data related to the servers may include asset inventory systems for midrange servers (2), server monitoring tools (3), a management database containing detailed server and application information (4), and a system for providing information on utilization, such as CPU utilization (5). Additional sources for providing data related to storage devices may include systems for providing information regarding usage data relevant to Network Attached Storage (NAS) (6) or systems for monitoring the storage information relevant to Storage Area Network (SAN) storage (7). Even further, sources may include systems for providing information on costs related to the application (8), and application level details (9). However, this list is not exhaustive and other data sources may be used depending on the aspects of the technology infrastructure.

Processing and Analyzing the Data

As seen in FIG. 1, the second step of the process is to process and evaluate the raw data that has been gathered from the different data sources in step one. As discussed, there may be an exorbitant amount of data relating to the above described targeted aspects of the organization's technology infrastructure. It would be desirable to condense the information into a form that allows the reader to quickly and easily access the data. For example, it would be beneficial to an organization's management if the data is conveyed in a simple, organized and concise manner.

Therefore, this second step of the process may include a database (10) into which all the raw data collected. As shown in FIG. 1, this database may be a relational database (in this case a SQL database). A series of procedures, processes are performed on the raw data. The data is first normalized so that data elements such as server models and operating system names are consistent throughout the data set. Then summation and tallying operations are done for each metric element of the score card. These results are then stored for use in analysis and reporting. The series of procedures, processes or algorithms produce modified data in analyzing the organization's technology infrastructure.

From this modified data, hardware transparency may be realized so that that an organization's management has knowledge to make informed decisions regarding the capability of its technology infrastructure. Further, when organized correctly this data is a tool to determine how to optimize the technology infrastructure. For example, the data may show the amount of non-core software and hardware, where such non-core software and hardware is located, the capacity and underutilization of the hardware, etc. This information may be used to determine where changes to the technology infrastructure may be made and how they may be implemented. For example, the transparency will allow the organization make the changes to the targeted aspects described above, such as migrating operating systems to consistent versions of an operating system, streamlining the infrastructure to consolidate core hardware and remove non-core hardware and reconfiguring the remaining core hardware to increase its efficiency and thereby decreasing the amount of data centers, the overall power consumption and environmental impact resulting from the energy consumed by the technology infrastructure.

The modified data may be presented in several formats. For example, as shown in FIG. 1, the modified data may be presented in the form of one or more spreadsheets or tables (11). These spreadsheets or tables may be organized or categorized in several ways depending on the particular organization and information conveyed (11a, 11b, 11c, 11d).

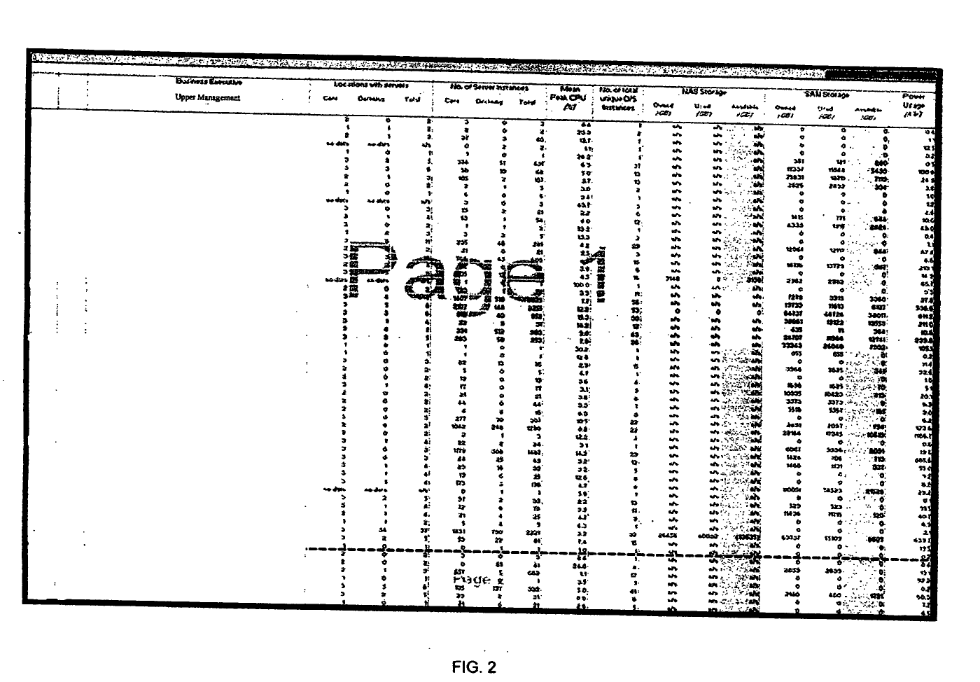

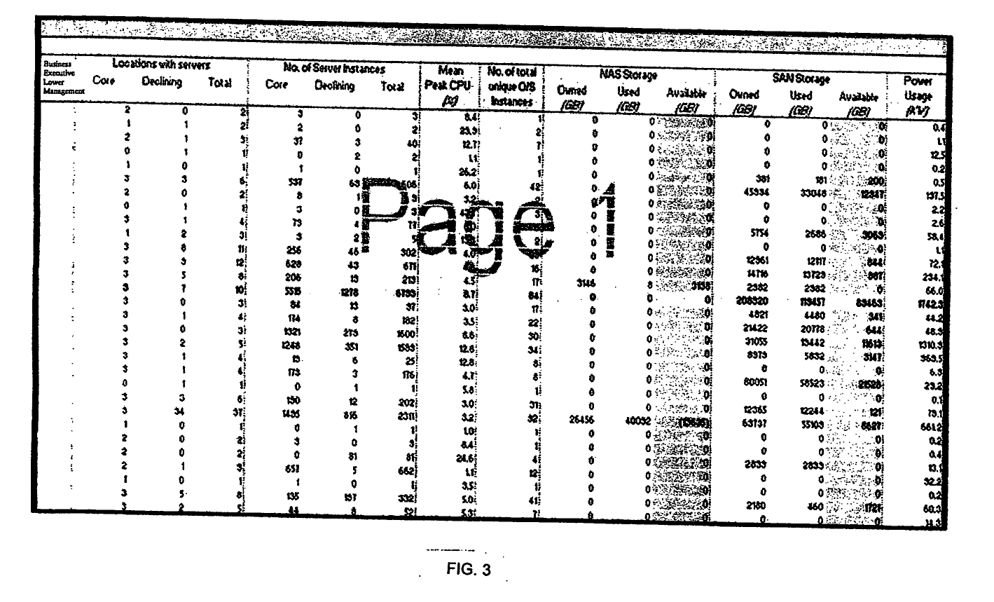

By way of example, in the above described embodiment regarding organization's computer servers and storage data, the second step includes the raw data regarding the servers being put through the series of SQL procedures to produce modified data which is then imported into spreadsheets (11). In this example, the spreadsheets contain information regarding the servers and the storage capacity of the technology infrastructure. For example, in FIG. 1, 11a shows a table with raw data, 11b shows modified data organized according to application, 11c and 11d show modified data organized according to particular persons responsible for implementing changes. FIGS. 2 and 3 shows the summarized tables 11c and 11d that contain the information regarding the applications used by an organization wherein information is categorized by the business executive overseeing or responsible for that part of the organization's technology infrastructure. Specifically, as can be seen in FIG. 2, the table discloses the location of the servers, the number of servers, whether the servers are non-core or core, the mean peak CPU utilization of the servers the number of operating systems regarding the servers, the storage capacity and the power usage and further which business executive is responsible for such items. Similarly FIG. 3 shows an example of a series of the summarized tables that contain the similar information as that of FIG. 2, but wherein such information is broken down to a different level of business executive that is responsible for that part of organization's technology infrastructure. This variety of reports shown in the second step of FIG. 1, demonstrates that the output from the second step may be organized in various manners depending on the particular needs of the organization.

Metric Target Reporting

As seen in FIG. 1, the third step or component is using the information output from the second step or component to create goals for implementing changes to the existing technology infrastructure in order to optimize it. The management of the organization can decide specific targets regarding the general overall goals. Further, the management can determine how and when to reach such targets.

For example, in the embodiment shown in FIG. 1, based on the output spreadsheets from the second step or component, the management of the organization can decide specific targets regarding the general overall goals of: standardizing the operating systems, remediation of out of date hardware, maximizing the CPU and storage utilization of the hardware, reducing the number of data centers and decreasing the power consumption and corresponding environmental impact. As seen in the third step of FIG. 1, such a specific target may be migration of all of the non-core operating systems to core operating systems within a predetermined amount of time or by a specific date. Other specific targets could include decommissioning a specific amount of the non-core server hardware within a predetermined amount of time or by a specific date, increasing the CPU utilization rate by a specific amount within a predetermined amount of time or by a specific date, increasing the overall storage rate by a specific amount within a predetermined amount of time or by a specific date, reducing the number of data centers by a specific amount within a predetermined amount of time or by a specific date, reducing the power consumption of the organization by a specific amount within a predetermined amount of time or by a specific date. Of course, the particular goals may vary depending on the organization, but the ability to make these goals and decisions remains the same.

The Report Card

Once these goals have been established, it would be desirable to monitor the progress towards those goals in order to ensure they will be completed according to the on schedule set during the third step. As previously noted, there may be an exorbitant amount of information relating to the above described targeted aspects of the organization's technology infrastructure. Therefore, just as in the second step, where it was desirable to condense the information into a concise form to allow the reader to understand the existing status of the technology infrastructure in order to create the goals, it is just as desirable here to condense and organize the progress towards achieving these goals and targets in a concise manner to allow the reader to quickly and easily understand the goals and the current progress of reaching those goals and targets.

Therefore, as seen in FIG. 1, the fourth step or component is to report the progress towards reaching the goal created in the third step or component in a manner that is concise and simple for the reader to understand. One embodiment of such a consolidated report according to an aspect of this invention is a “report card”. As the term the “report card” would tend to imply, the report may be a single page, however this is not required. This report card is a tool for an organization's management. This tool allows the management to make further decisions regarding the technology infrastructure and its status on achieving the already created goals.

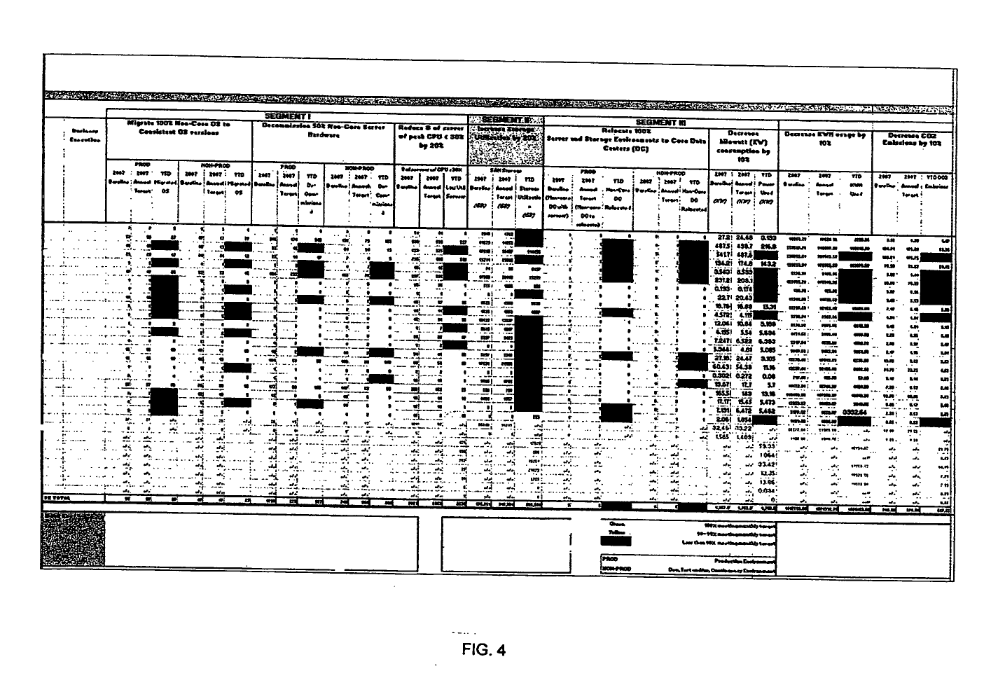

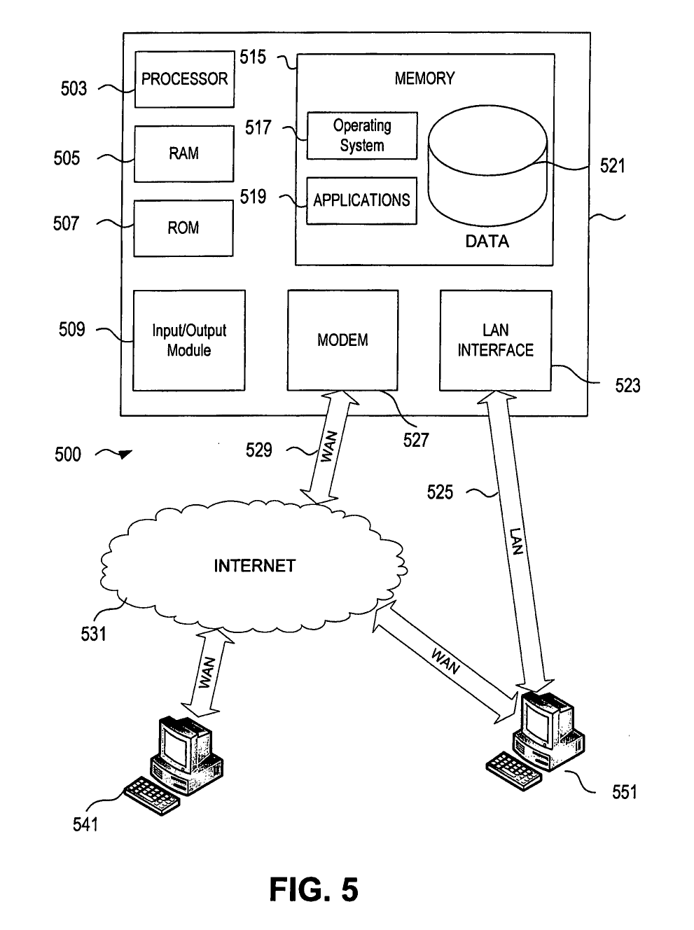

An illustrative embodiment of a report card is shown in FIG. 4. In the embodiment shown in FIG. 4, the report card conveys information discussed above regarding the technology infrastructure as it relates to the infrastructure's computer servers, storage devices, data centers, power consumption and environment effects of the power consumption.

The report card may contain the general goals (created in the third step) to be achieved by modifying the organization's technology structure. The report card may organize these goals in a plurality of segments. One segment of the report card may identify the status of a modernization and reconfiguration of software and hardware within the technology infrastructure. As seen in the embodiment shown in FIG. 4, this is shown in segment I. The report card may include a second segment for identifying the status of an increase of the storage utilization in the technology infrastructure. As seen in the embodiment shown in FIG. 4, this is shown in segment II. The report card may include a third segment for identifying the status of a reduction and consolidation of resources in the technology infrastructure. As seen in the embodiment shown in FIG. 4, this is shown in segment III. Of course, the segments may depend on the particular organization and its particular goals.

The segments of the report card may be divided into sectors representing particular targeted aspects or goals to be achieved to optimize the technology infrastructure. For example, in the embodiment shown in FIG. 4, the first segment may include a first sector directed to identifying the status of a migration of non-core operating systems to consistent operating systems in the technology infrastructure; a second sector for identifying the status of decommissioning of non-core hardware in the technology infrastructure; and a third sector for identifying a status of the efficiency or utilization of the hardware within the technology infrastructure.

Similarly, in the embodiment shown in FIG. 4, the third segment may include a first sector for identifying a status of a relocation of the hardware to particular locations within the organizations, a second sector for identifying a decrease in power consumption, and a third sector for identifying a decrease in environmental consequences associated with the optimization of the technology infrastructure. Of course, the sector may depend on the particular organization and its particular goals.

The report card may further be organized to show the current status of each of the goals and whether particular components are being met within certain predetermined parameters, such as a predetermined time. This is may be used by the organization's management because it may ascertain whether particular goals are on schedule to be met. To show the current status of such goals, the report card may include sections within each of the components.

For example, each of the sector may include at least a first section for identifying a baseline of tasks which need to be completed to totally achieve the goal of the section's respective c sector, a second section for identifying how many of the baseline of tasks need to be completed within a predetermined time period and a third section which determines how many of the tasks have actually been completed. In other words, the embodiment shown in FIG. 4, segment I's component relating to migration of 100% of non-core operating system to core operation system versions, includes six sections. The first section identifies a baseline of non-core operating systems which need to be migrated to core operating systems. A second section identifies how many of the baseline operating systems need to be migrated within a predetermined time. A third section identifies how many of the non-core operating systems have actually been migrated to consistent operating systems to date. (The additional three sections represent similar information in a non-production environment). As seen in the FIG. 4 the first, second and third sections are positioned adjacent to each other. Additionally, the third section may be color coded to represent a particular status of the goal and whether the goal will be completed with in the predetermined time. For example, the third section may be coded green if the goal is on target to be completed within the predetermined time, yellow if it is not quite on schedule to be completed within the predetermined time, or red if the goal is not on target to be completed within the predetermined time. In the embodiment shown in the FIG. 4, the report card is a monthly report and the green can represent that 100% of the monthly target has been met, while yellow can represent that 90-99% of the monthly target has been met, and red can represent that less than 90% of the monthly target has been met. While the embodiment in FIG. 4 is on a monthly basis, it is noted that the reporting may be continued on a different basis.

Further, the report card may include information regarding a person or persons that are responsible for implementing or overseeing particular changes to the organization's technology infrastructure. For example, a business executive may be listed. Therefore, if a particular goal was coded with a yellow or red indicator, the management could ascertain which business executive needs to be contacted to perform additional steps that may be needed to ensure that particular goals are met by the predetermined times.

The organization of the report card is such that it can be read left to right to see how the particular goals will lead to end results. For example, the first step is migrating the non-core operating system to consistent operating systems. This migration allows the decommissioning of the non-core hardware and increases the CPU and storage-utilizations. The decreases in hardware and increases in CPU and storage utilization will then allow data centers to be consolidated. The consolidation of data centers then allows power and its corresponding environmental impact to be reduced. In short, the report card is organized to allow the reader to see the overall process and end results in a concise manner in order to manage the organization to the end results wanted, including the reduction of fixed costs.

FIG. 5 illustrates a block diagram of a generic computing device 501 (e.g., a computer server) that may be used according to an illustrative embodiment of the invention. The computer server 501 may have a processor 503 for controlling overall operation of the server and its associated components, including RAM 505, ROM 507, input/output module 509, and memory 515.

I/O 509 may include a microphone, keypad, touch screen, and/or stylus through which a user of device 501 may provide input, and may also include one or more of a speaker for providing audio output and a video display device for providing textual, audiovisual and/or graphical output. Software may be stored within memory 515 and/or storage to provide instructions to processor 503 for enabling server 501 to perform various functions. For example, memory 515 may store software used by the server 501, such as an operating system 517, application programs 519, and an associated database 521. Alternatively, some or all of server 501 computer executable instructions may be embodied in hardware or firmware (not shown). As described in detail below, the database 521 may provide centralized storage of account information and account holder information for the entire business, allowing interoperability between different elements of the business residing at different physical locations.

The server 510 may operate in a networked environment supporting connections to one or more remote computers, such as terminals 541 and 551. The terminals 541 and 551 may be personal computers or servers that include many or all of the elements described above relative to the server 501. The network connections depicted in FIG. 5 include a local area network (LAN) 525 and a wide area network (WAN) 529, but may also include other networks. When used in a LAN networking environment, the computer 501 is connected to the LAN 125 through a network interface or adapter 523. When used in a WAN networking environment, the server 501 may include a modem 527 or other means for establishing communications over the WAN 529, such as the Internet 531. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 519 used by the server 501 according to an illustrative embodiment of the invention may include computer executable instructions for invoking user functionality related to communication, such as email, short message service (SMS), and voice input and speech recognition applications.

Computing device 501 and/or terminals 541 or 551 may also be mobile terminals including various other components, such as a battery, speaker, and antennas (not shown).

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the features of the aforementioned illustrative examples may be utilized alone or in combination or subcombination with elements of the other examples. It will also be appreciated and understood that modifications may be made without departing from the true spirit and scope of the present invention. The description is thus to be regarded as illustrative instead of restrictive on the present invention.

For example, it is important to note that this method and system can be applied to any type of organization. While the data sources of step one and, therefore, the raw data may change depending on the organization, the particular organization will still achieve the resulting optimization of its technology infrastructure.

In other words, the system may include interfaces which will allow the process or system to “map” the raw data of different organizations. Therefore, except for the raw data in the first step the process and system shown in the flow chart of FIG. 1 can remain the same for any organization. Hence, this process and system may be used to produce reports specific to each different organization and thereby achieve optimization of the technology infrastructure of that particular organization.

1. A system for optimizing a technology infrastructure of an organization comprising:
a component configured to collect source data from various aspects of a technology infrastructure;
a component configured to process the source data to generate information regarding the technology infrastructure;
a component configured to create goals regarding an optimization process of the technology infrastructure based on the information from the processed source data; and
a component configured to organize the goals so that the goals are presented in a report.

2. The system of claim 1, wherein the optimization of the technology infrastructure includes modifying the technology infrastructure by migrating non-core operating systems of hardware in the technology infrastructure to consistent operating systems.

3. The system of claim 2, wherein the optimization of the technology infrastructure includes modifying the technology infrastructure by leveraging the hardware so that non-core hardware is removed and remaining core hardware is reconfigured to absorb functions that were previously on the non-core hardware.

4. The system of claim 3, wherein the hardware is directed to supporting and operating computer servers.

5. The system of claim 4, wherein the optimization of the technology infrastructure includes modifying the technology infrastructure by maximizing the CPU and storage utilization of the remaining core hardware.

6. The system of claim 5, wherein the optimization of the technology infrastructure includes modifying the technology infrastructure by reducing locations in the organization.

7. The system of claim 6, wherein the optimization of the technology infrastructure includes modifying the technology infrastructure by decreasing the power consumption.

8. The system of claim 6, the component for collecting the source data collects information about software applications used by the organization, information about the computer servers, including information on the CPU utilization and storage utilization, and information on costs related to the technology infrastructure.

9. The system of claim 8, wherein the component for processing the source data includes a database which collects the source data and applies a series of SQL procedures to the source data to generate an output regarding the existing status of technology infrastructure.

10. The system of claim 9, wherein the output is one or more tables of modified data organized according to a person or persons responsible for a particular aspect of the technology infrastructure.

11. The system of claim 10, wherein the component for creating goals allows a user to use the processed source data to determine goals for optimizing the technology infrastructure wherein said goals relate to at least one or more of:
migrating non-core operating systems of hardware in the technology infrastructure to consistent operating systems;
leveraging the hardware so that non-core hardware is removed and remaining core hardware is reconfigured to absorb functions that were previously on the non-core hardware;
maximizing the CPU and storage utilization of the remaining core hardware;
reducing locations in the organization;
decreasing the power consumption of the organization; and
decreasing the environmental impact of the organization.

12. The system of claim 11, wherein the component for organizing the goals arranges the goals in the report wherein all the goals are positioned so that when viewed from left to right, the goals on the left side of the report enable the goals to the right of it to be accomplished.

13. The system according to claim 12, wherein the report identifies a status of a technology infrastructure for the organization and includes:
a segment for identifying a status of a modernization and reconfiguration of software and hardware within the technology infrastructure; and
a segment for identifying a status of a reduction and consolidation of resources in the technology infrastructure.

14. The system according to claim 13, wherein the report is organized according to a person, or persons, responsible for a particular aspect of the technology infrastructure.

15. The system according to claim 14, further includes a segment for identifying a status of an increase of the storage utilization in the technology infrastructure.

16. The system according to claim 15, wherein the segment for identifying the status of the modernization and reconfiguration the software and hardware within the technology infrastructure includes:
a sector for identifying a status of a migration of non-core operating systems to consistent operating systems in the technology infrastructure;
a sector for identifying a status of decommissioning of non-core hardware in the technology infrastructure; and
a sector for identifying a status of the efficiency or utilization of the software or hardware within the technology infrastructure.

17. The system according to claim 16, wherein the segment for identifying the status of the reduction and consolidation of resources in the technology infrastructure includes:
a sector for identifying a status of a relocation of the hardware to particular locations within the organizations;
a sector for identifying a decrease in power consumption; and
a sector for identifying a decrease in environmental consequences.

18. The system according to claim 17, wherein the sectors of the report include at least a first section for identifying a proposed goal of its respective sector, a second section for identifying a current status of its respective sector and a third section which compares the first and section sections,
wherein the first, second and third sections are positioned adjacent to each other and further wherein the third section comparing the first two section is color-coded to indicate whether the current status is within particular parameters to complete the goal.

19. A process for optimizing a technology infrastructure of an organization comprising:
collecting source data from various aspects of technology infrastructure;
processing the source data to generate information regarding the technology infrastructure;
creating goals regarding the optimization process of the technology infrastructure based on the information from the processed source data; and
generating a report wherein the goals are presented.

20. The process according to claim 19, wherein the step of collecting the source data includes collecting information about software applications used by the organization, information about the computer servers, including information on the CPU utilization and storage utilization, and information on costs related to the technology infrastructure.

21. The process according to claim 20, wherein the step of processing the source data includes applying a series of SQL procedures to the source data to generate an output regarding the existing status of technology infrastructure.

22. The process according to claim 21, wherein the step of creating goals includes viewing the output of the processed source data and determining goals for optimizing the technology infrastructure wherein the goals relate to at least one or more of:
migrating non-core operating systems of hardware in the technology infrastructure to consistent operating systems;
leveraging the hardware so that non-core hardware is removed and remaining core hardware is reconfigured to absorb functions that were previously on the non-core hardware; and
maximizing the CPU utilization and storage utilization of the remaining core hardware.

23. The process according to claim 22, wherein the goals further relate to:
reducing locations in the organization;
decreasing the power consumption of the organization; and
decreasing the environmental impact of the organization.

24. The process according to claim 23, wherein the report is organized so that the goals are arranged in the report so that when viewed from left to right, the goals on the left side of the report enable the goals to the right of it to be accomplished.

25. A system for optimizing a technology infrastructure of an organization comprising:
a sub-system for collecting source data from various aspects of technology infrastructure and processing the source data to generate information regarding the technology infrastructure;
a sub-system for creating goals regarding the optimization process of the technology infrastructure based on the information from the processed source data;
a sub-system for generating a report wherein the goals are presented;
wherein the optimization of the technology infrastructure includes
migrating non-core operating systems of hardware in the technology infrastructure to consistent operating systems;
leveraging the hardware so that non-core hardware is removed and remaining core hardware is reconfigured to absorb functions that were previously on the non-core hardware;
maximizing the CPU and storage utilization of the remaining core hardware;
reducing locations in the organization;
decreasing the power consumption of the organization; and
decreasing the environmental impact of the organization.
